(19) United States
(12) Patent Application Publication
(10) Pub. No.: US 2014/0284485 A1
(43) Pub. Date: Sep. 25, 2014

(54) RADIATION DETECTING DEVICE AND RADIATION DETECTING SYSTEM

(71) Applicant: CANON KABUSHIKI KAISHA, Tokyo (JP)

(72) Inventors: Kazumi Nagano, Honjo-shi (JP); Satoshi Okada, Tokyo (JP); Keiichi Nomura, Honjo-shi (JP)

(73) Assignee: CANON KABUSHIKI KAISHA, Tokyo (JP)

(21) Appl. No.: 14/211,915

(22) Filed: Mar. 14, 2014

(30) Foreign Application Priority Data
Mar. 21, 2013 (JP) 2013-058501

(51) Int. Cl. G01T 1/17; G01T 1/20

(52) U.S. Cl. CPC G01T 1/17; G01T 1/2006
USPC 250/366; 250/336.1; 250/361 R; 250/393

(57) ABSTRACT

A radiation detecting device of a cassette type having flexibility includes a deformation maintaining mechanism configured to maintain a state of the radiation detecting device that is deformed to match an arbitrary surface profile of a subject. The deformation maintaining mechanism is arranged on at least one of a surface of a sensor panel on a sensor substrate side and a surface of the sensor panel on a scintillator side.

### BACKGROUND OF THE INVENTION

1. Field of the Invention

The present invention relates to a radiation detecting device and a radiation detecting system.

2. Description of the Related Art

A radiation detecting device is employed in a medical image diagnosis device, a non-destructive test device, an analysis device, and the like. In order to obtain a quality image by this type of radiation detecting device, it is required to deform the radiation detecting device into a shape that matches a surface profile of a subject.

As a technology related to the deformation of the radiation detecting device, for example, an X-ray diagnosis device including a solid-state X-ray detector that is formed in a flexible manner and includes a flexible housing, a flexible substrate including a matrix of thin film transistors (TFTs), and a flexible X-ray converter has been proposed in Japanese Patent No. 4,436,593. According to the X-ray diagnosis device disclosed in Japanese Patent No. 4,436,593, the solid-state X-ray detector can be formed to match an arbitrary surface profile.

Further, in Japanese Patent Application Laid-Open No. 2001-095789, an X-ray fluoroscopic imaging device has been proposed, in which an imaging mechanism is a spherical two-dimensional X-ray detector including a large number of X-ray detecting elements that are two-dimensionally arranged on a concave surface of a flexible base protruded in an X-ray radiation direction, and a curvature of the two-dimensional X-ray detector changes depending on a distance between an X-ray tube and the two-dimensional X-ray detector. Although the radiation detecting device (solid-state X-ray detector) disclosed in Japanese Patent No. 4,436,593 has flexibility, the radiation detecting device lacks a deformation maintaining mechanism for maintaining a state of being deformed to match the surface profile of the subject, and hence it is not possible to maintain the deformation.

Moreover, the radiation detecting device (spherical two-dimensional X-ray detector) disclosed in Japanese Patent Application Laid-Open No. 2001-095789 can maintain the state of being deformed, but the radiation detecting device is in a spherical shape, and hence the deformation is limited to a predetermined unidirectional curvature change. In addition, a driving mechanism for the deformation maintaining mechanism is large in size, and hence the mechanism can only be applied to a stationary radiation detecting device.

### SUMMARY OF THE INVENTION

According to one embodiment of the present invention, there is provided a radiation detecting device of a cassette type having flexibility, the radiation detecting device including: a sensor panel including a conversion element configured to convert a radiation into an electrical signal; and a deformation maintaining mechanism configured to maintain a state of the radiation detecting device that is deformed into an arbitrary shape.

Further, according to one embodiment of the present invention, there is provided a radiation detecting system, including: the above-mentioned radiation detecting device; a signal processing unit configured to process a signal from the radiation detecting device; a recording unit configured to record a signal from the signal processing unit; a display unit configured to display the signal from the signal processing unit; and a transmission processing unit configured to transmit the signal from the signal processing unit. The radiation detecting device according to one embodiment of the present invention has flexibility, and is configured to be deformed into an arbitrary shape to match an arbitrary surface profile of a subject, and to maintain the deformation. Therefore, the radiation detecting device can be installed or arranged without being limited to a particular subject or a particular photographing condition, and hence a quality image can be obtained in an on-bed photography, a mammography, a four-limbs photography, and a photography of a piping structure or the like. Thus, the radiation detecting device according to one embodiment of the present invention can be widely used as a radiation detecting device of a medical image diagnosis device, a non-destructive test device, an analysis device, and the like.

Further features of the present invention will become apparent from the following description of exemplary embodiments with reference to the attached drawings.

### BRIEF DESCRIPTION OF THE DRAWINGS

FIGS. 1A, 1B and 1C are cross-sectional views of an example of a radiation detecting device according to the present invention.

FIG. 2 is a cross-sectional view of another example of the radiation detecting device according to the present invention.

FIG. 3A is a plan view of a resin sheet having a shape maintaining function.

FIG. 3B is a schematic perspective view of the resin sheet having the shape maintaining function.

FIG. 4 is a schematic perspective view of an example of an ion gel actuator.

FIGS. 5A and 5B are cross-sectional views of an example of a deformation drive maintaining mechanism to be driven due to an air pressure.

FIGS. 6A, 6B, 6C, 6D and 6E are views illustrating an example of block partitioning of the deformation drive maintaining mechanism.

FIGS. 7A, 7B, 7C, 7D and 7E are views illustrating another example of the block partitioning of the deformation drive maintaining mechanism.

FIGS. 8A and 8B are views illustrating still another example of the block partitioning of the deformation drive maintaining mechanism.

FIGS. 9A and 9B are views illustrating still another example of the block partitioning of the deformation drive maintaining mechanism.

FIG. 10 is a schematic diagram of a radiation detecting system employing the radiation detecting device according to the present invention.

### DESCRIPTION OF THE EMBODIMENTS

The present invention has been achieved in view of the above-mentioned circumstances, and it is an object of the present invention to provide a portable radiation detecting device configured to be deformed into an arbitrary shape to match an arbitrary surface profile of a subject, and to maintain the deformation.

A radiation detecting device and a radiation detecting system according to the present invention are described below with reference to the accompanying drawings. In the present invention, a radiation includes an electromagnetic wave such as X-ray, α-ray, β-ray, and γ-ray.

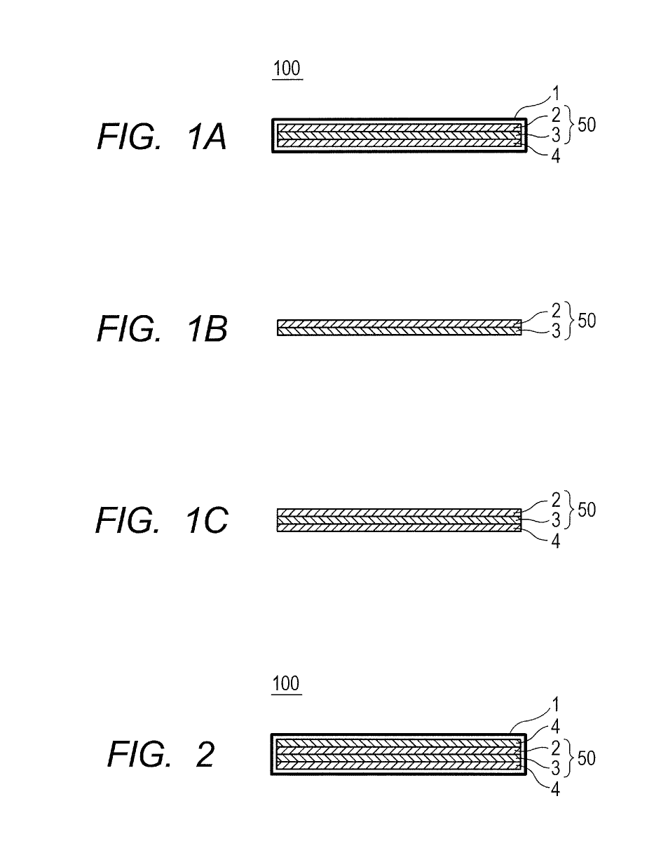

A radiation detecting device 100 according to the present invention is described first with reference to FIGS. 1A to 9B. FIGS. 1A to 1C are cross-sectional views of an example of the radiation detecting device 100 according to the present invention.

As illustrated in FIG. 1A, the radiation detecting device 100 is a radiation detecting device of a cassette type, which includes a housing 1, a sensor panel 50, and a deformation maintaining mechanism 4. The sensor panel 50 and the deformation maintaining mechanism 4 are accommodated in the housing 1. The radiation detecting device 100 has flexibility, and hence the radiation detecting device 100 can be deformed into an arbitrary shape, for example, to match an arbitrary surface profile of a subject. The deformation maintaining mechanism 4 maintains a state of the radiation detecting device 100 that is deformed into the arbitrary shape.

As illustrated in FIG. 1B, the sensor panel 50 includes a sensor substrate 3 and a scintillator 2. Photoelectric conversion elements (not shown) that convert scintillator light into an electrical signal, and a signal extracting unit (not shown) that extracts the electrical signal are formed on a substrate of the sensor substrate 3. The photoelectric conversion elements are arranged on the substrate in a two-dimensional manner. The scintillator 2 is provided at least on the photoelectric conversion elements of the sensor substrate 3, and converts the radiation into light that is detectable by the photoelectric conversion elements. The photoelectric conversion elements and the scintillator 2 can constitute a conversion element that converts the radiation into the electrical signal. However, the conversion element according to the present invention is not limited thereto, but, for example, can be a conversion element that is formed of amorphous selenium or the like and directly converts the radiation into the electrical signal.

An electrical mounting component is connected to the signal extracting unit of the sensor substrate 3, and as illustrated in FIG. 1C, the deformation maintaining mechanism 4 is laminated on a surface of the sensor panel 50 on the sensor substrate 3 side. An electrical mounting substrate, a sensor panel support substrate, or the like is further laminated if necessary, and the entire components are covered by the housing 1, with the result that the radiation detecting device 100 illustrated in FIG. 1A is manufactured.

FIG. 2 is a cross-sectional view of another example of the radiation detecting device 100 according to the present invention. As illustrated in FIG. 2, another example of the radiation detecting device 100 differs from the radiation detecting device 100 illustrated in FIGS. 1A to 1C in that the deformation maintaining mechanism 4 is laminated on both surfaces of the sensor panel 50.

In FIGS. 1A to 1C and 2, the substrate of the sensor substrate 3 is an insulating substrate formed of, for example, glass, particularly glass having a thickness of 0.3 mm or less, a heat-resistant plastic, an Si wafer, or the like.

The sensor substrate 3 serving as the insulating substrate includes a photoelectric conversion element area, in which a photoelectric conversion element, a switch element, and a gate wiring for transferring an on/off signal of the switch element are formed. As the photoelectric conversion element, for example, amorphous silicon, an organic semiconductor material, or the like can be used. A signal from the gate wiring is extracted by the signal extracting unit and transferred to the outside of the radiation detecting device 100 by using a wired or wireless data transferring unit. In order to improve the flexibility of the sensor substrate 3, it is desired to use an organic material as the materials of the substrate and the photoelectric conversion element.

The scintillator 2 that absorbs the radiation and emits light is formed on the photoelectric conversion element of the sensor substrate 3. A scintillator protecting layer (not shown) is formed on the scintillator 2 for the purpose of improving resistance to humidity and protecting the scintillator 2 with rigidity. The scintillator protecting layer may have a structure that also serves as a reflection layer or a structure including a separate reflection layer. A conventionally known material can be used for the scintillator protecting layer and the reflection layer.

The scintillator 2 converts the radiation into light that is detectable by the photoelectric conversion element. A generally used fluorescent material can be used as the scintillator 2, and for example, a fluorescent material having a columnar crystal or a particulate fluorescent material can be used.

In the scintillator formed of a fluorescent material having the columnar crystal, light generated from the fluorescent material propagates through the columnar crystal, and hence the light is less scattered so that the resolution can be improved. A material containing an alkali halide as a main component is suitably used as a material of the scintillator forming the columnar crystal. For example, CsI:Tl, CsI:Na, CsBr:Tl, NaI:Tl, LiI:Eu, or KI:Tl is used. As a production method using CsI:Tl, there may be given, for example, a method involving simultaneously depositing CsI and TlI.

The scintillator formed of a particulate fluorescent material can easily be formed by applying and drying a fluorescent material paste in which particulate crystals are dispersed in a resin binder. A fluorescent material which has been known conventionally, such as CaWO₄, Gd₂O₂S:Tb, or BaSO₄:Pb, is desired as the powder for the scintillator.

The deformation maintaining mechanism 4 may be arranged on a surface of the sensor panel 50 on the sensor substrate side, on a surface of the sensor panel 50 on the scintillator side, or on both surfaces of the sensor panel 50. When the deformation maintaining mechanism 4 is arranged on a radiation incident side (scintillator 2 side), in order to prevent reduction of an information amount, it is preferred to form the deformation maintaining mechanism with a material that does not absorb the radiation significantly. When the deformation maintaining mechanism 4 is arranged on an opposite side of the radiation incident side (sensor substrate 3 side), in order to prevent increase of noise, it is preferred to form the deformation maintaining mechanism 4 with a material that does not generate a scattered ray significantly. In view of these aspects, it is desired to form the deformation maintaining mechanism 4 with a resin.

As the material of the deformation maintaining mechanism 4, a resin having a shape maintaining function (variable shape maintaining resin) can be used, and particularly, a sheet shaped resin can be suitably used. The resin sheet having the shape maintaining function can be cut into a desired size and used by being bonded to the sensor panel 50.

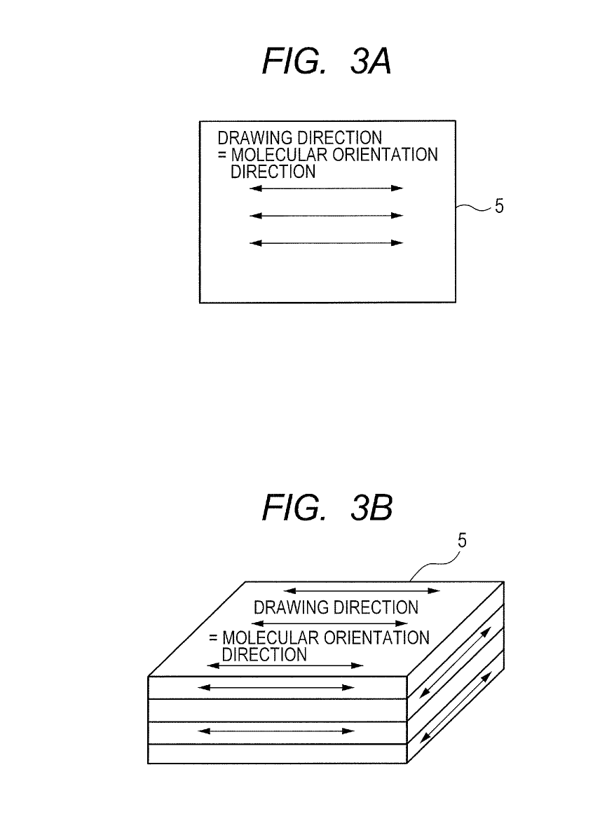

FIGS. 3A and 3B are views illustrating an example of a resin sheet 5 having the shape maintaining function in the radiation detecting device according to the present invention. FIG. 3A is a plan view of the resin sheet 5, and FIG. 3B is a schematic perspective view of the resin sheet 5. As illustrated in FIGS. 3A and 3B, for example, a so-called superdrawing resin sheet in which molecular chain orientation is improved by drawing can be used as the resin sheet 5 having the shape maintaining function. The superdrawing resin sheet may be used as a laminated body including multiple resin sheets laminated so that the orientation directions become perpendicular to each other in an alternate manner as illustrated in FIG. 3B, or may be used as a single layer.

As the material of the superdrawing resin sheet, a drawing material of a polyolefin-based resin can be used. When a total draw ratio of the superdrawing resin sheet is small, shape maintaining property may be insufficient, and when the total draw ratio of the superdrawing resin sheet is large, the resin sheet is likely to be laterally ruptured. Thus, a total draw ratio of 10 to 40 is appropriate, and a total draw ratio of about 15 to 35 is desired.

Any polyolefin-based resin having film formability can be used as the polyolefin-based resin. Examples thereof include: polyethylene resins such as high density polyethylene, medium density polyethylene, low density polyethylene, and linear low density polyethylene; and polypropylene. As a copolymer thereof, there are given, for example, ethylene-based copolymers such as an ethylene-propylene copolymer, an ethylene-pentene-1 copolymer, an ethylene-vinyl acetate copolymer, an ethylene-(meth)acrylic acid ester copolymer, an ethylene-vinyl chloride copolymer, and an ethylene-propylene-butene copolymer. Of those, high density polyethylene is suitably used.

Such a sheet is commercially available, and for example, Forte manufactured by SEKISUI CHEMICAL CO., LTD. (trade name, a polyethylene stretched sheet) can be used.

It is preferred that the deformation maintaining mechanism 4 be a deformation drive maintaining mechanism configured to deform the radiation detecting device into the arbitrary shape to match an arbitrary surface profile of a subject, and to maintain the state of the radiation detecting device that is deformed into the arbitrary shape. Further, it is preferred that the deformation drive maintaining mechanism be formed into a sheet shape, and that the deformation drive maintaining mechanism be configured to deform the radiation detecting device by being curved. Specifically, the deformation drive maintaining mechanism includes a mechanism including a polymer resin to be expanded and contracted through application of a voltage, a mechanism to be driven due to an air pressure, a mechanism that is driven due to a piezoelectric effect of a piezoelectric element or the like, a mechanism that is driven due to a temperature difference of a bimetal or the like, a mechanism that is driven through expansion and contraction of a moisture absorption material due to moisture, and a mechanism that is driven due to an electromagnetic force. The deformation drive maintaining mechanism can be formed into a desired size and used by being bonded to the sensor panel 50.

As the mechanism including a polymer resin to be expanded and contracted through application of a voltage, a polymer actuator can be used. The polymer actuator is a so-called expansion and contraction drive element in which a polymer material is expanded and contracted through application of a voltage. This element is driven due to an electrochemical reaction or an electrochemical process such as charging and discharging of an electrical double layer. The polymer actuator includes the following actuators:
Conductive polymer actuator using expansion and contraction in an electrolyte of a conductive polymer;
Ion conduction actuator including an ion exchange membrane and a junction electrode and configured to function as an actuator by applying a potential difference to the ion exchange membrane in a hydrous state of the ion exchange membrane to generate curve or deformation on the ion exchange membrane; and
Ion gel actuator including a polymer gel composition containing an ionic fluid sandwiched by electrodes respectively formed of carbon and ion gel and configured to generate deformation by applying a potential difference.

As the conductive polymer actuator, for example, a conductive polymer actuator disclosed in Japanese Patent No. 4,562,507 can be used, and as the ion gel actuator, for example, ion gel actuators disclosed in Japanese Patent No. 4,038,685 and Japanese Patent No. 4,931,002 can be used.

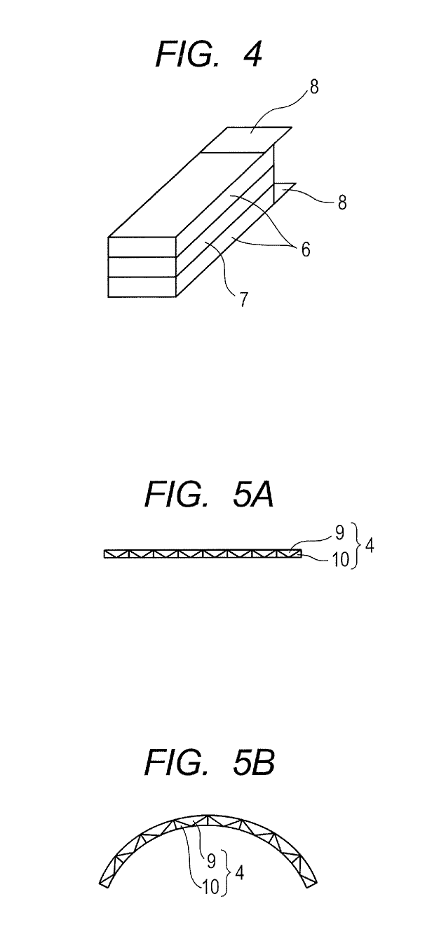

FIG. 4 is a schematic perspective view of an example of the ion gel actuator. The ion gel actuator illustrated in FIG. 4 has a laminated structure including ion gel 7 sandwiched by a pair of electrodes 6 and 6 formed of carbon and ion gel, and an electrical wiring 8 is connected to each of the electrodes 6 and 6. As illustrated in FIG. 4, a sheet-shaped actuator including a polymer material sandwiched by the pair of electrodes is preferred as the polymer actuator.

Such a polymer actuator is also commercially available, and for example, a polymer actuator manufactured by EAMEX Corporation can be used.

As the mechanism to be driven due to the air pressure, for example, as illustrated in FIGS. 5A and 5B, a resin sheet including multiple air chambers partitioned by partition walls can be used. FIG. 5A is a cross-sectional view of the resin sheet in a state before being deformed, and FIG. 5B is a cross-sectional view of the resin sheet in a state after being deformed. As illustrated in FIG. 5A, the resin sheet includes an upper air chamber 9 and a lower air chamber 10 partitioned by the partition walls, and air pressures of the upper air chamber 9 and the lower air chamber 10 are adjusted to be equal to each other. When the air pressures are adjusted so that the air pressure of the upper air chamber 9 is higher than the air pressure of the lower air chamber 10, as illustrated in FIG. 5B, the resin sheet is deformed into a curved shape that is convex on the upper air chamber 9 side.

It is preferred that the deformation drive maintaining mechanism 4 be partitioned into multiple blocks to be driven in an independent manner. For example, in the polymer actuator, a direction of deformation and a degree of deformation are determined by an applied voltage, but when the polymer actuator is partitioned into multiple blocks to be driven in an independent manner, the direction of deformation and the degree of deformation can be set for each of the blocks. Therefore, the radiation detecting device 100 can be deformed to match a more complicated surface profile of a subject. The deformation drive maintaining mechanism 4 can be formed by partitioning a single mechanism into multiple blocks or by arranging multiple mechanisms of the same type or different types.

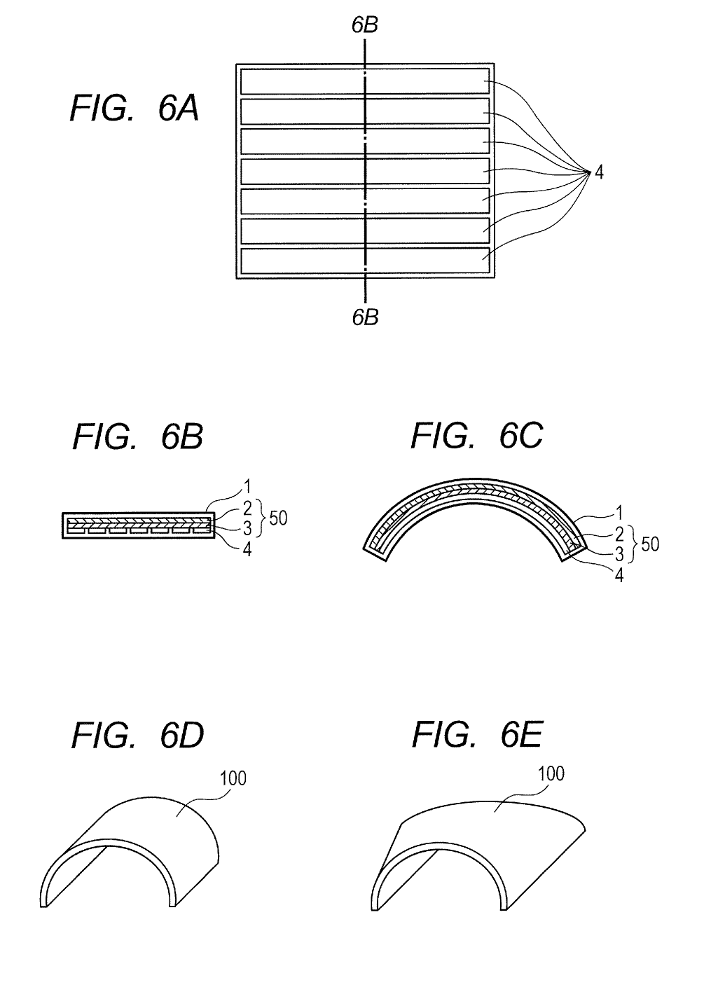

FIGS. 6A to 6E are views illustrating an example of the block partitioning of the deformation drive maintaining mechanism. FIG. 6A is a plan view of the radiation detecting device, FIG. 6B is a cross-sectional view cut along the line 6B-6B of FIG. 6A, FIG. 6C is a cross-sectional view illustrating a state of the radiation detecting device after the deformation as viewed from a direction perpendicular to the line 6B-6B, and FIGS. 6D and 6E are perspective views illustrating a state of the radiation detecting device after the deformation.

As illustrated in FIG. 6A, the deformation drive maintaining mechanism 4 is partitioned into multiple blocks parallel to one side of the sensor panel 50, that is, a long side of the sensor panel 50. As illustrated in FIG. 6B, the deformation drive maintaining mechanism 4 is arranged on a surface of the sensor panel 50 on the sensor substrate 3 side. The deformation drive maintaining mechanism 4 is configured to control the drive for each of the blocks, and hence the radiation detecting device can be deformed into a complicated shape.

There is described a case where, as the deformation drive maintaining mechanism 4, multiple polymer actuators having the structure illustrated in FIG. 4, in which the expansion and contraction are generated on a negative electrode side and the degree of the expansion and contraction is determined by the applied voltage level, are arranged in each of the blocks. When the voltage is applied with the electrode of the polymer actuator on the sensor panel 50 side as a negative side, the radiation detecting device 100 is deformed into a curved shape that is concave on the sensor panel 50 side. On the other hand, when the voltage is applied with the electrode of the polymer actuator on the sensor panel 50 side as a positive side, as illustrated in FIG. 6C, the radiation detecting device 100 is deformed into a curved shape that is convex on the sensor panel 50 side. When the applied voltage is the same for the entire blocks, as illustrated in FIG. 6D, the entire radiation detecting device 100 is deformed with the same curvature in a deformation direction of the deformation drive maintaining mechanism. On the other hand, when the level of the applied voltage to each of the blocks is gradually decreased from a farthest edge block to a farthest edge block on the other side, as illustrated in FIG. 6E, the radiation detecting device 100 is deformed with a gradually smaller curvature toward the other side.

When the radiation detecting device 100 can be deformed with a different curvature for each of the blocks in the above-mentioned manner, photography can be performed in accordance with a surface profile of a portion of a subject to be photographed and a peripheral profile thereof. With the deformation as illustrated in FIG. 6E, for example, when an upper portion of a femoral area is to be photographed, the radiation detecting device 100 is arranged in a manner that a portion having a large curvature is fitted on the femoral area and a portion having a small curvature is fitted on the buttocks. Thus, the radiation detecting device 100 can be arranged in conformity to the subject so that the subject can be photographed with a reduced distance from the radiation source.

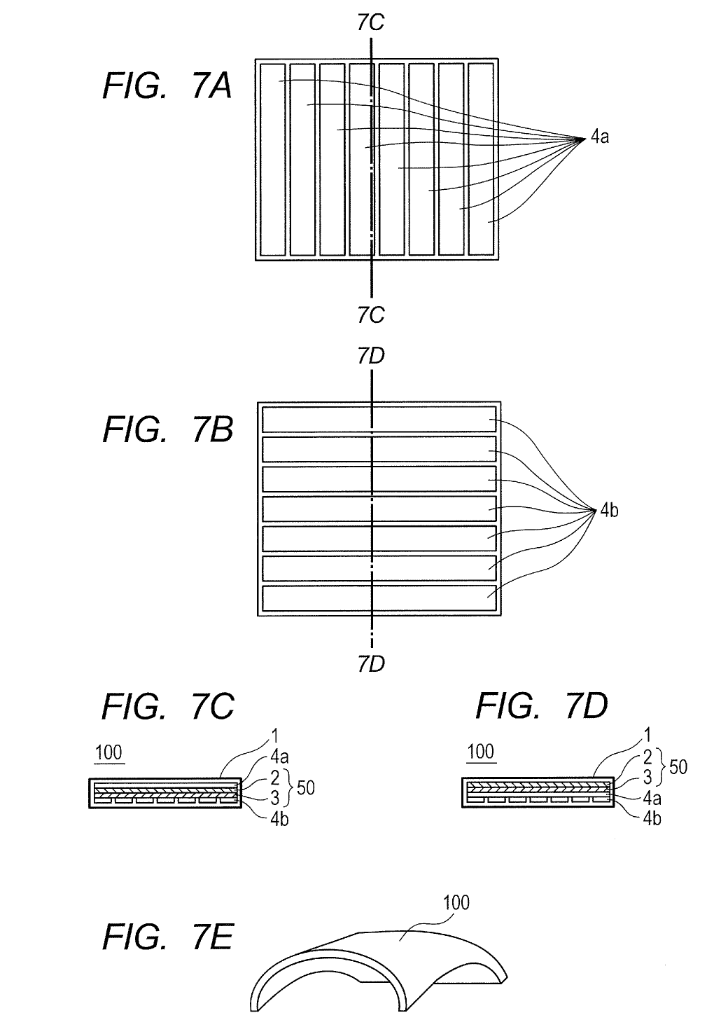

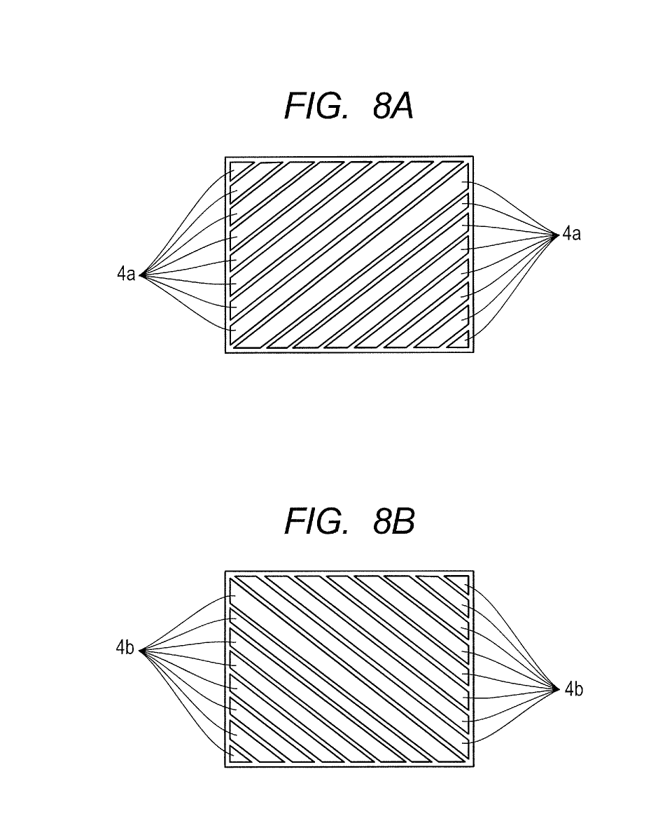

FIGS. 7A to 7E are views illustrating another example of the block partitioning of the deformation drive maintaining mechanism. FIGS. 7A and 7B are plan views of the radiation detecting device, FIGS. 7C and 7D are cross-sectional views cut along the line 7C-7C and 7D-7D of FIGS. 7A and 7B, respectively, and FIG. 7E is a perspective view illustrating a state of the radiation detecting device after the deformation.

The radiation detecting device illustrated in FIGS. 7A to 7E includes two deformation drive maintaining mechanisms 4a and 4b independent from each other. As illustrated in FIG. 7A, the deformation drive maintaining mechanism 4a is partitioned into multiple blocks parallel to one side of the sensor panel 50, that is, a short side of the sensor panel 50. As illustrated in FIG. 7B, the deformation drive maintaining mechanism 4b is partitioned into multiple blocks parallel to another side of the sensor panel 50, that is, a long side of the sensor panel 50. That is, in FIGS. 7A and 7B, the deformation drive maintaining mechanisms 4a and 4b are partitioned in a manner that longitudinal directions of the blocks are perpendicular to each other. In the example illustrated in FIG. 7C, the deformation drive maintaining mechanism 4a is arranged on a surface of the sensor panel 50 on the scintillator 2 side, and the deformation drive maintaining mechanism 4b is arranged on a surface of the sensor panel on the sensor substrate 3 side. In the example illustrated in FIG. 7D, the deformation drive maintaining mechanism 4a is arranged on the surface of the sensor panel on the sensor substrate 3 side, and the deformation drive maintaining mechanism 4b is arranged on the deformation drive maintaining mechanism 4a. The deformation drive maintaining mechanisms 4a and 4b are configured to control the drive for each of the blocks, and hence the radiation detecting device can be deformed into a complicated shape. For example, when a half of the radiation detecting device 100 is curved by driving the deformation drive maintaining mechanism 4a and the other half of the radiation detecting device 100 is curved by driving the deformation drive maintaining mechanism 4b, the radiation detecting device 100 can be deformed into a shape as illustrated in FIG. 7E.

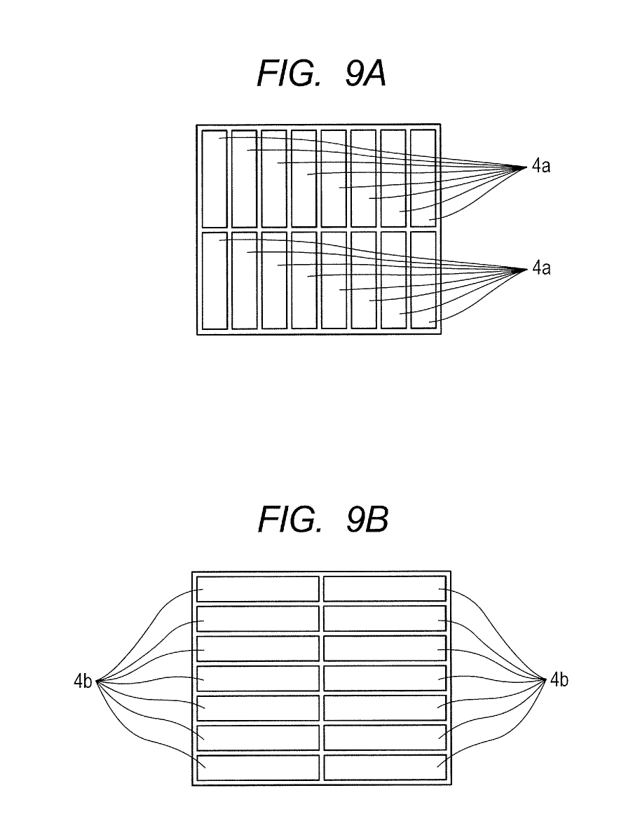

The block partitioning of the deformation drive maintaining mechanism is not limited to the patterns illustrated in FIGS. 6A to 6E and FIGS. 7A to 7E. For example, the blocks can be partitioned as illustrated in FIGS. 8A and 8B and FIGS. 9A and 9B instead of the patterns illustrated in FIG. 6A or FIGS. 7A and 7B. In FIGS. 8A and 8B, each of the deformation drive maintaining mechanisms 4a and 4b is partitioned into multiple blocks parallel to a diagonal line of the sensor panel 50 in a manner that the longitudinal directions of the blocks of the deformation drive maintaining mechanisms 4a and 4b are diagonally perpendicular to each other. In FIG. 9A, the block of the deformation drive maintaining mechanism 4a illustrated in FIG. 7A is further partitioned at a position that bisects the short side of the sensor panel. In FIG. 9B, the block of the deformation drive maintaining mechanism 4b illustrated in FIG. 7B is further partitioned at a position that bisects the long side of the sensor panel.

It is desired that the deformation drive maintaining mechanism 4 be configured to reproduce the state of the radiation detecting device that is deformed, for example, because the photography can be performed later under the same condition to compare the obtained images for confirmation of a temporal change. The reproduction of the state of the radiation detecting device that is deformed can be implemented by the deformation drive maintaining mechanism including a mechanism for detecting the state of the radiation detecting device that is deformed. As the mechanism for detecting the state of the radiation detecting device that is deformed, a unit that detects and stores the deformed shape can be used or a unit that detects and stores data input to the deformation drive maintaining mechanism 4 can be used.

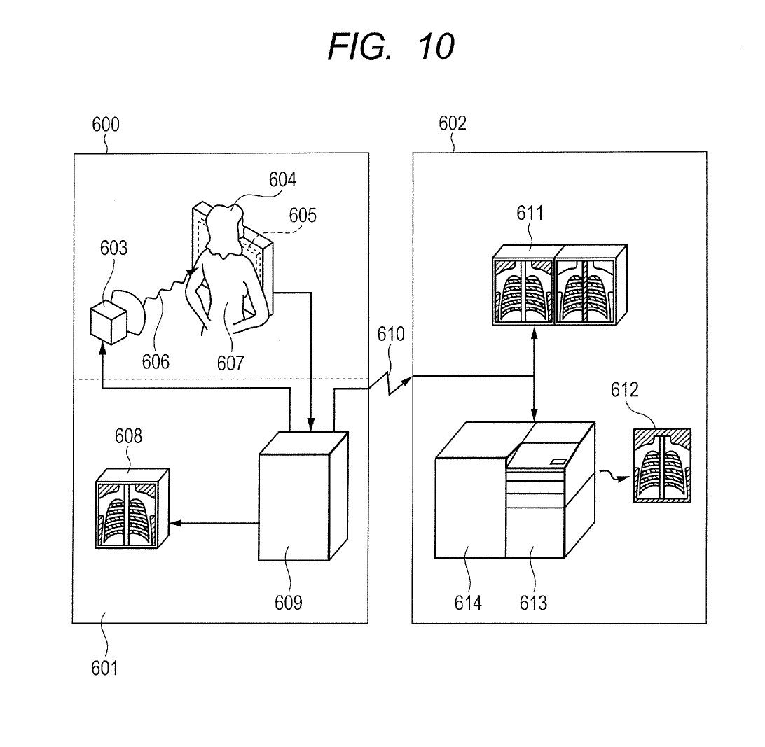

FIG. 10 is an explanatory diagram illustrating an example of applying the radiation detecting device according to the present invention to a radiation detecting system.

As illustrated in FIG. 10, in an X-ray room 600, an X-ray 606 generated from an X-ray tube 603 serving as a radiation source passes through a chest area 607 of a patient or subject 604 and enters a radiation detecting device 605. The X-ray thus entering the radiation detecting device 605 contains information on the inside of the body of the patient or subject 604. A scintillator (fluorescent material layer) emits light in response to the entry of the X-ray, and the emitted light is subjected to photoelectric conversion by a photoelectric conversion element of a sensor substrate, to thereby obtain electrical information. This information is converted into digital information and subjected to image processing by an image processor 609 serving as a signal processing unit, and an image can be observed on a display 608 serving as a display unit in a control room 601.

Further, this information can be transferred to a remote place by a transmission processing unit such as a telephone line 610, and hence the information can be displayed on a display 611 serving as a display unit or recorded on a recording unit such as an optical disc in a doctor room 602 or the like at a different place so that a doctor at the remote place can perform a diagnosis. In addition, the information can be recorded on a paper or film 612 by a laser printer 613 or a film processor 614 serving as a recording unit.

The radiation detecting device according to the present invention is described in detail below with reference to examples.

### Example 1

A sensor substrate 3 was manufactured by forming photoelectric conversion elements at a pitch of 160 μm and a wire drawing portion on the substrate. As the substrate, a polyimide substrate (30 mm×40 mm in size) was used as a heat-resistant plastic resin.

A sensor panel 50 was obtained by forming cesium iodide at a thickness of 200 μm by vapor deposition as the scintillator 2 on the sensor substrate 3 and bonding an aluminum/PET laminated sheet as a humidity-resistant protecting layer via a hot-melt resin (FIG. 1B).

A Forte manufactured by SEKISUI CHEMICAL CO., LTD. (12 layer type, 30 mm×40 mm in size) was bonded as the deformation maintaining mechanism 4 onto a surface of the sensor panel 50 on the sensor substrate 3 side with an adhesive sheet (FIG. 1C).

A radiation detecting device 100 was obtained by mounting an electrical component on the wire drawing portion of the sensor substrate 3 and covering the entire components with a housing 1 (FIG. 1A).

The obtained radiation detecting device 100 was able to be deformed to match the surface profile of the subject, and the deformation was able to be maintained by the deformation maintaining mechanism 4.

### Example 2

A sensor panel 50 was obtained in a similar manner to Example 1 except that a glass substrate (300 mm×400 mm in size) having a thickness of 0.2 mm was used as the substrate.

Seven polymer actuators (42 mm×400 mm in size) were arranged and bonded as the deformation drive maintaining mechanism 4 onto a surface of the sensor panel 50 on the sensor substrate 3 side with an adhesive sheet (FIG. 6A).

A radiation detecting device 100 was obtained by mounting an electrical component on the wire drawing portion of the sensor substrate 3 and covering the entire components with a housing 1 (FIG. 6B).

The obtained radiation detecting device 100 was able to be deformed in accordance with the direction of deformation and the degree of deformation of the polymer actuators by changing a ratio of expansion and contraction through drive of the polymer actuators at a voltage of 0 V to 1.5 V. Further, the shape was able to be maintained.

### Example 3

A sensor panel 50 was obtained in a similar manner to Example 2.

Eight polymer actuators (300 mm×50 mm in size) were arranged and bonded as the deformation drive maintaining mechanism 4a onto a surface of the sensor panel 50 on the sensor substrate 3 side with an adhesive sheet (FIG. 7A). Further, seven polymer actuators (42 mm×400 mm in size) were arranged and bonded as the deformation maintaining mechanism 4b with an adhesive sheet in a manner of being laminated on the deformation drive maintaining mechanism 4a (FIG. 7B).

A radiation detecting device 100 was obtained by mounting an electrical component on the wire drawing portion of the sensor substrate 3 and covering the entire components with a housing 1 (FIG. 7D).

The obtained radiation detecting device 100 was able to be deformed into a desired shape in both longitudinal and lateral directions in accordance with the direction of deformation and the degree of deformation of the polymer actuators by changing a ratio of expansion and contraction through drive of the polymer actuators at a voltage of 0 V to 1.5 V. Further, the shape was able to be maintained.

As described above, the radiation detecting device 100 obtained in Examples 1 to 3 exhibited a good flexibility and a good deformation maintaining force, and were deformed to match a subject, and hence a quality image was obtained in an on-bed photography, a mammography, a four limbs photography, and a photography of a piping structure or the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-058501, filed Mar. 21, 2013, which is hereby incorporated by reference herein in its entirety.

What is claimed is:

1. A radiation detecting device of a cassette type having flexibility, the radiation detecting device comprising:
a sensor panel comprising a conversion element configured to convert a radiation into an electrical signal; and
a deformation maintaining mechanism configured to maintain a state of the radiation detecting device that is deformed into an arbitrary shape.

2. The radiation detecting device according to claim 1, wherein the deformation maintaining mechanism comprises a deformation drive maintaining mechanism configured to deform the radiation detecting device into the arbitrary shape to match an arbitrary surface profile of a subject, and to maintain the state of the radiation detecting device that is deformed into the arbitrary shape.

3. The radiation detecting device according to claim 2, wherein the deformation drive maintaining mechanism is configured to deform the radiation detecting device by being curved.

4. The radiation detecting device according to claim 2, wherein the deformation drive maintaining mechanism is formed into a sheet shape.

5. The radiation detecting device according to claim 2, wherein the deformation drive maintaining mechanism is partitioned into multiple blocks to be driven in an independent manner.

6. The radiation detecting device according to claim 2, wherein the deformation drive maintaining mechanism comprises a mechanism including a polymer resin to be expanded and contracted through application of a voltage.

7. The radiation detecting device according to claim 2, wherein the deformation drive maintaining mechanism comprises a mechanism to be driven due to an air pressure.

8. The radiation detecting device according to claim 2, wherein the deformation drive maintaining mechanism is configured to reproduce the state of the radiation detecting device that is deformed into the arbitrary shape.

9. The radiation detecting device according to claim 8, wherein the deformation drive maintaining mechanism comprises a mechanism configured to detect the state of the radiation detecting device that is deformed into the arbitrary shape.

10. The radiation detecting device according to claim 1, wherein the deformation maintaining mechanism is made of a resin having a shape maintaining function.

11. The radiation detecting device according to claim 10, wherein the deformation maintaining mechanism comprises a resin sheet having the shape maintaining function.

12. The radiation detecting device according to claim 1, wherein the conversion element comprises:
a photoelectric conversion element; and
a scintillator configured to convert the radiation into light that is detectable by the photoelectric conversion element.

13. The radiation detecting device according to claim 12,
wherein the sensor panel comprises:
a sensor substrate comprising a substrate having the photoelectric conversion elements arranged thereon in a two-dimensional manner; and
the scintillator provided on the photoelectric conversion elements, and
wherein the deformation maintaining mechanism is arranged on at least one of a surface of the sensor panel on the sensor substrate side and a surface of the sensor panel on the scintillator side.

14. A radiation detecting system, comprising:
the radiation detecting device according to claim 1;
a signal processing unit configured to process a signal from the radiation detecting device;
a recording unit configured to record a signal from the signal processing unit;
a display unit configured to display the signal from the signal processing unit; and
a transmission processing unit configured to transmit the signal from the signal processing unit.

15. The radiation detecting system according to claim 14, further comprising a radiation source configured to generate the radiation.
